(19) United States
(12) Patent Application Publication
(10) Pub. No.: US 2007/0174194 A1
(43) Pub. Date: Jul. 26, 2007

(54) Check-Printing Machine and Payroll System

(76) Inventor: Daryl K. Chappell, York, PA (US)

Correspondence Address: HARSHAW RESEARCH, INC., 210 W. TECUMSEH STREET, OTTAWA, KS, 66067, US

(21) Appl. No.: 11/306,483

(22) Filed: Dec. 29, 2005

(51) Int. Cl. G06Q 40/00; G07F 19/00

(52) U.S. Cl. 705/45

(57) ABSTRACT

A payroll system includes at least one interface station having a processor, an input device, a printer, paper such as blank check stock, and a display. The payroll system includes a company payroll computer system remote from the kiosk that includes payroll compensation and benefit data. The company computer and kiosk are communicatively connected with a network information system. The kiosk input device may be a keyboard, scanner, barcode reader, fingerprint reader, or other suitable devices and are used for employee authentication, updating benefit data, or even receipt reimbursement. The kiosk may also be connected to a banking computer or network for making bank transactions such as directing funds from one's payroll to a checking account or retirement account.

The present invention relates generally to payroll systems and, more particularly, to a computer implemented payroll system that enables employees to access their payroll data, to receive their payroll checks at a remote computer kiosk, and to selectively control related personal banking activities related to payroll.

Payroll departments in many instances become overloaded by the tasks of calculating and processing paychecks, government mandated reports, updating employee benefit information, processing vacation accruals, sick time, garnishments, expense reports, etc. A typical payroll department at a medium or large sized company is not only tasked with calculating payroll, printing paychecks, and coordinating benefits, but also with delivering the paychecks personally or by mail. In some cases, employees—potentially thousands of them—must report to a payroll office to pick up their paycheck. Distribution of paychecks and related services to employees is often a source of frustration to employees.

Various devices and systems for efficient payroll processing have been proposed in the art. Although assumably effective for their intended purposes, the existing devices and systems do not provide comprehensive access to employee payroll and benefit data from a remote payroll kiosk, including the printing of paychecks, controlling bank transactions, and reducing overall payroll department costs.

Therefore, it would be desirable to have a payroll system that prints paychecks on actual check stock at a remote interface station, provides adequate data security to employee data, and provides transactional access to an employee's bank records. Further, it would be desirable to have an electronic payroll system that substantially reduces the cost of administering a payroll and benefit program.

### SUMMARY OF THE INVENTION

A payroll system according to the present invention includes a remote kiosk, also referred to herein as an interface station, that will reduce or eliminate much of the overload and inefficiency experienced by both payroll departments and employees. Of course, multiple kiosks may be arranged side by side on company property or dispersed about a metropolitan area for maximum convenience to employees, similar to the dispersion of automatic teller machines (ATM's). The kiosk includes at least one input device such as a keyboard, touch screen, or scanner. The station also includes a printer and paper such as blank check stock so that actual paychecks may be printed rather than just a record of the transaction, as is the case of existing systems. A processor is in communication with the input device or devices and manages communications with remote computers through appropriate electronic information networks. More particularly, the interface station may be in communication with a company computer so that payroll and benefit data may be accessed or updated. Additionally, the station may be simultaneously interconnected with a banking network to manage financial transactions as desired by a user.

Each kiosk includes several types of security features. A camera is positioned on the kiosk for recording physical activities adjacent thereto. A security camera is useful both to enhance personal security and also to deter criminal activity such as theft. The station also provides for data security by requiring a pin number, security code, barcode reader to read an employee's identification code, or fingerprint reader.

Therefore, a general object of this invention is to provide an electronic payroll system that simplifies the workload on a payroll department by providing electronic access to employees through one or more remote electronic payroll kiosks.

Another object of this invention is to provide an electronic payroll system, as aforesaid, that prints actual paychecks on demand at a remote kiosk upon authentication that a user is an authorized employee.

Still another object of this invention is to provide an electronic payroll system, as aforesaid, which enables an authorized employee to access a company payroll computer through a remote kiosk.

Yet another object of this invention is to provide an electronic payroll system, as aforesaid, in which a remote payroll kiosk is electronically connected to a national banking information network.

A further object of this invention is to provide an electronic payroll system, as aforesaid, in which an authorized employee may access employee benefit data from a company computer using the remote kiosk.

A still further object of this invention is to provide an electronic payroll system, as aforesaid, in which an employee may conduct financial transactions in conjunction with accessed payroll information.

A particular object of this invention is to provide an electronic payroll system which saves time and money related to processing, printing, distributing, or mailing paychecks and human resource information.

Other objects and advantages of this invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of an electronic payroll system according to a preferred embodiment of the present invention;

FIG. 2a is a front view of the payroll system as in FIG. 1;

FIG. 2b is a sectional view of the payroll system taken along line 2b-2b of FIG. 2a;

FIG. 3 is a block diagram schematically illustrating the components of the payroll system; and

FIG. 4 is a flowchart illustrating the logic of the processor of the payroll system.

### DESCRIPTION OF THE PREFERRED EMBODIMENT

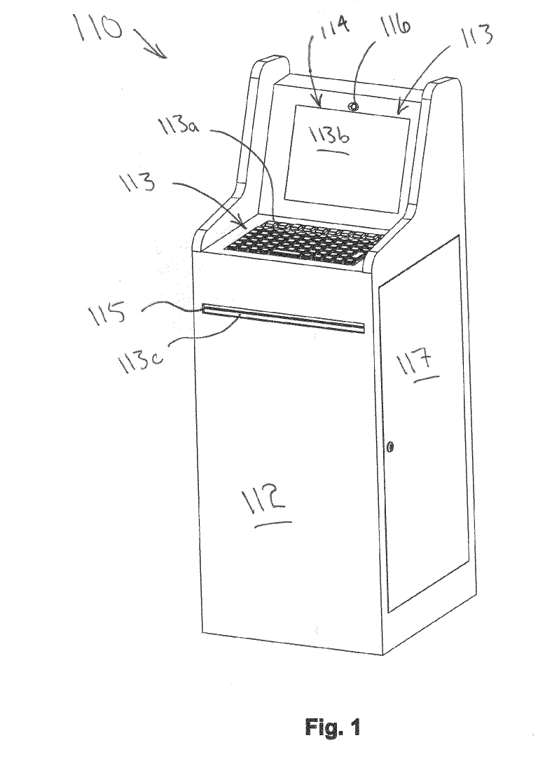

A payroll system 100 according to the present invention will now be described in detail with reference to FIGS. 1 through 4 of the accompanying drawings. More particularly, a payroll system 100 according to the current invention includes an interface station 110 and a remote computer 120.

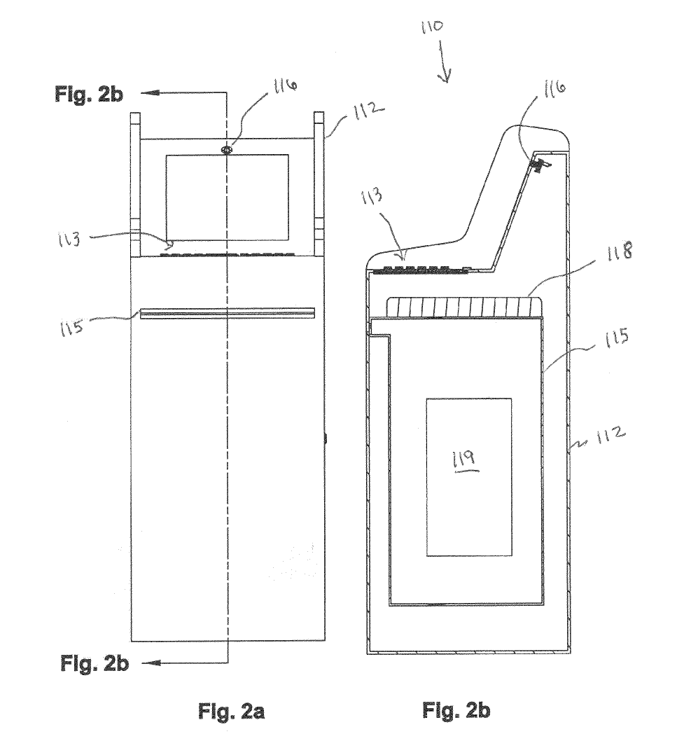

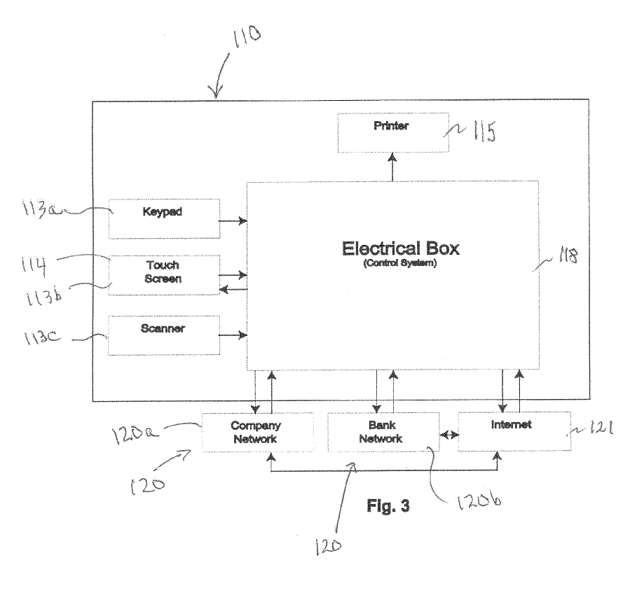

As shown in FIGS. 1 through 2b, the interface station 110 (also referred to as a kiosk 110 or a check printing machine 110) may include a housing 112, an input device 113, a display 114, a printer 115, a camera 116, and a lockable access door 117. The printer 115 is preferably encased in the housing 112. A processor 118 may also be included inside the housing 112, and paper 119 may be inside the housing 112 so that the printer 115 may print indicia on the paper 119. The processor 118, the printer 115, and the paper 119 may be selectively accessed through the lockable access door 117 such as for maintenance and re-supply purposes. The processor 118 is in communication with the input device 113, the printer 115, and the display 114 as shown in FIG. 3, and the processor 118 preferably includes software for communicating between the interface station 110 and the remote computer 120 and for using data from the input device 113 and the remote computer 120 to control the printer 115, as will be described in more detail below.

The paper 119 may include blank check stock, and the indicia may include check data. This allows the printer 115 to print actual paychecks or reimbursement checks on the spot without the need to stock form checks. As such, it is inexpensive to change check formats (such as to update company name or address information,) and there is less incentive for someone to break into the housing 112 and steal the paper 119. The paper 119 may also include multipurpose paper, and the indicia may include account data. This enables the printer 115 to print information related to a user's account, such as check stubs, income tax information, benefit information, etc.

The input device 113 may be a keypad 113a, a touch screen 113b, a scanner 113c, or another input device, and multiple input devices 113 may be used. A scanner 113c enables a user to input receipts for reimbursement purposes. Card readers (i.e., a barcode reader or a magnetic strip reader) are also suitable input devices 113, among others. A fingerprint reader is also contemplated for authenticating a user who is attempting to access the system.

The remote computer 120 is preferably remote from the interface station 110, and an electronic network may connect the interface station processor 118 and the remote computer 120. The remote computer 120 may be a company payroll computer system 120a, a bank computer system 120b, and/or another financial computer system, as shown in FIG. 3. The electronic information network may be a wide area network 121 (i.e., the internet), or another network, and at least a part of the electronic information network may be wireless to facilitate installation of the interface stations 110 without having to install networking cables or for other convenience reasons. Wireless communications such as satellite transmissions (not shown) would also enable the remote paycheck delivery system of the present invention to be used aboard naval vessels and the like. The processor 118 may include programming for communicating between the kiosks 110, the company payroll computer system 120a, and the bank computer system 120b, and programming for using data obtained from the input devices 113, the company payroll computer system 120a, and the bank computer system 120b to control the printer 115.

It should be clearly understood that the payroll system 100 may include multiple kiosks 110 as well as multiple remote computers 120 (i.e., multiple bank computer systems 120b and multiple company payroll computer systems 120a). In fact, multiple kiosks may be positioned on company property, such as in a cafeteria, in various break rooms, or in another predetermined location so that employees may obtain their paychecks or conduct other transactions at their convenience during the work day. Or, the multiple kiosks may be arranged remotely from company property such as a network of stations situated about a metropolitan area. It should also be understood that a company payroll computer system 120a may also include information not related to payroll, such as company benefit information.

Further, it should be appreciated that the payroll system 100 may be utilized by several different companies. Each “subscribing” company would have its own payroll computer system 120a in communication with the kiosk processor 118 for directing the printer 115 to print appropriate paychecks, reimbursements, etc. This is especially feasible in that the kiosk 110 prints the checks on demand rather than utilizing pre-printed stock.

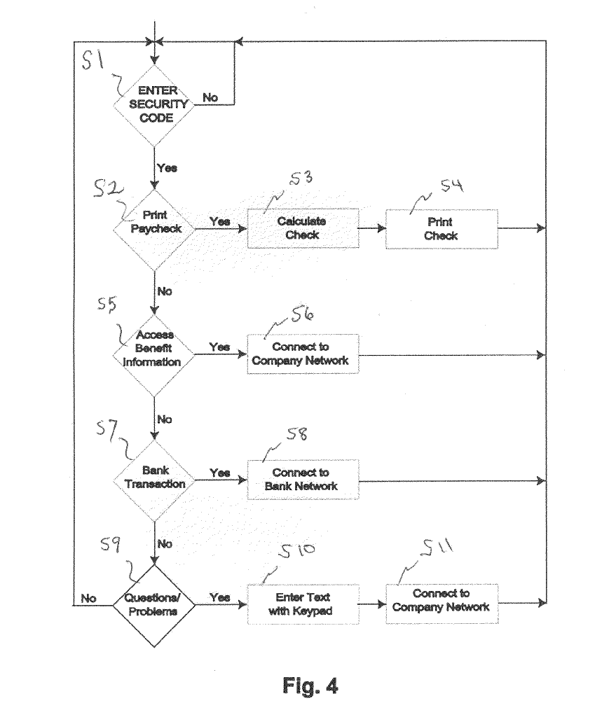

FIG. 4 shows an exemplary method of using the payroll system 100. At a first step S1, a user may approach the interface station 110 and identify and authenticate himself through an input device 113. He may input a code into a key pad 113a or a touch screen 113b (e.g. a pin number), swipe a card having a magnetic strip, use an electronic key fob, scan a card having a barcode, have a biometric reading taken (i.e., fingerprints, eye scans, etc.), etc. If the processor 118 accepts the data from the input device 113 and authenticates the user, the process continues to step S2. If not, the process returns to the beginning.

At step S2, the processor 118 may inquire as to whether the user wishes to print a paycheck or reimbursement check through displaying a question on the display 114, audibly asking such a question by using a speaker in communication with the processor 118, or through other methods. If the user responds affirmatively through the input device 113, the process continues to step S3; if the user responds negatively through the input device 113, the process proceeds to step S5.

At step S3, the processor 118 may calculate the user's check (preferably by contacting the company payroll computer system 120a), and the process proceeds to step S4. At step S4, the processor 118 instructs the printer 115 to print an appropriate check in accordance with the calculations performed at step S3, which is then provided to the user. It is understood that the processor 118, in cooperation with the payroll computer system 120a may refuse to print a paycheck until a predetermined date and time or, to calculate and print a partial paycheck in the case where an employee is requesting a paycheck prior to the end of a pay period.

At step S5, the processor 118 may inquire as to whether the user wishes to access account information through displaying a question on the display 114 or through other methods. If the user responds affirmatively through the input device 113, the processor 118 may connect to the company payroll computer system 120a as shown at step S6. If the user responds negatively through the input device 113, the processor 118 proceeds to step S7. At step S6, the user may print account data on the paper 119 using the printer 115. The processor 118 may access the company payroll computer system 120a through the programming and networking as described above. It is understood that any transactions such as printing a payroll check, updating information, etc. is recorded by the payroll computer 120a so that a duplicate (second) payroll check could not be generated again in another transaction.

At step S7, the processor 118 may inquire as to whether the user wishes to make a bank transaction through displaying a question on the display 114 or through other methods. If the user responds affirmatively through the input device 113, the processor 118 may connect to the bank computer system 120b as shown at step S8. If the user responds negatively through the input device 113, the processor 118 proceeds to step S9. The processor 118 may access the bank computer system 120b through the programming and networking as described above.

At step S9, the processor may inquire as to whether the user has a question or problem pertaining to the payroll system 100 through displaying a question on the display 114 or through other methods. If the user responds affirmatively through the input device 113, the user may then be allowed to describe the problem or question at step S10. If the user responds negatively through the input device 113, the process returns to step S1.

At step S10, the user may select a standard question or problem from a list using the input device 113, or the user may compose a specific question or problem using the input device 113. The process then proceeds to step S11.

At step S11, the processor connects to the company payroll computer system 120a and provides the question or problem to an automated response program or to a technician/clerk who may provide an answer or remedy the problem, preferably in real time through communications with the user at the kiosk 110 via the information network.

The process returns to step S1 from steps S4, S6, S8, and S11.

Also, the camera 116 may record activities adjacent the housing 112 for safety reasons, error verification, monitoring, etc. Images may then be stored locally or transferred through the information network to a remote location for storage and/or viewing. Sound may also be captured by the camera 116 and treated similarly to the corresponding images.

The scanner 113c may be used to transmit copies of receipts to the company payroll computer system 120a for reimbursement or for other tasks, and the scanner 113c may be incorporated into or separate from the printer 115.

It is understood that while certain forms of this invention have been illustrated and described, it is not limited thereto except insofar as such limitations are included in the following claims and allowable functional equivalents thereof.

What is claimed is:

1. An electronic payroll system, comprising:
an interface station having:
at least one input device;
paper;
a printer for printing indicia on said paper;
a display;
a processor in communication with said at least one input device, said printer, and said display;
at least one computer remote from said interface station; and
an electronic information network connecting said interface station processor and said at least one computer.

2. The payroll system as in claim 1, wherein:
said paper includes blank check stock; and
said indicia includes check data.

3. The payroll system as in claim 2, wherein:
said paper further includes multipurpose paper; and
said indicia further includes account data.

4. The payroll system as in claim 1, wherein:
said interface station includes a housing; and
said housing encases said paper, said printer, and said processor.

5. The payroll system as in claim 4, wherein said housing has a lockable access door through which said paper, said printer, and said processor may be selectively accessed.

6. The payroll system as in claim 4, wherein said interface station further includes a camera for recording activities adjacent the housing.

7. The payroll system as in claim 1, wherein said electronic information network is a wide area network.

8. The payroll system as in claim 1, wherein one said input device is a touch screen.

9. The payroll system as in claim 8, wherein another said input device is a keypad.

10. The payroll system as in claim 1, wherein one said input device is a scanner.

11. The payroll system as in claim 1, wherein at least a part of said electronic information network is wireless.

12. The payroll system as in claim 1, wherein said processor includes software for:
communicating between said interface station and said at least one computer; and
using data from said at least one input device and data from said at least one computer to control said printer.

13. The payroll system as in claim 1, wherein said at least one computer includes a company payroll computer system.

14. The payroll system as in claim 13, wherein said at least one computer includes a bank computer system.

15. The payroll system as in claim 14, wherein:
said paper includes blank check stock;
said indicia includes check data;
said paper includes multipurpose paper;
said indicia includes account data;
said interface station includes a housing; and
said housing encases said paper, said printer, and said processor.

16. The payroll system as in claim 15, wherein:
one said input device is a touch screen;
another said input device is a keypad; and
yet another said input device is a scanner.

17. A payroll system, comprising:
a plurality of kiosks, each kiosk having:
a processor;
at least one input device in communication with said processor; paper;
a printer in communication with said processor for selectively printing indicia on said paper;
a display in communication with said processor for selectively displaying information;
a company payroll computer system remote from said kiosks; and
an information network connecting said kiosks and said company payroll computer system.

18. The payroll system as in claim 17, wherein said processors are in communication with a remote bank computer system.

19. The payroll system as in claim 18, wherein a wide area network connects said processors, said company payroll computer system, and said bank computer system.

20. The payroll system as in claim 19, wherein:
at least part of said wide area network is wireless; and
said processors include programming for communicating between said kiosks, said company payroll computer system, and said bank computer system;
said processors include programming for using data from said input devices, said company payroll computer system, and said bank computer system to control said printers.
